(19) United States
(12) Patent Application Publication
(10) Pub. No.: US 2007/0278246 A1
(43) Pub. Date: Dec. 6, 2007

(54) CONTAINMENT BASE FOR A KITCHEN GREASE CONTAINER

(76) Inventors: Monty Berg, Regina (CA); Sherry Berg, Regina (CA)

Correspondence Address: GRAY, PLANT, MOOTY, MOOTY & BENNETT, P.A., P.O. BOX 2906, MINNEAPOLIS, MN, 55402-0906, US

(21) Appl. No.: 11/758,366

(22) Filed: Jun. 5, 2007

(30) Foreign Application Priority Data
Jun. 5, 2006 (CA) 2549490

(51) Int. Cl. B67D 5/60

(52) U.S. Cl. 222/131

(57) ABSTRACT

A containment base apparatus for containing kitchen grease spilled at a grease bin location includes a floor and walls extending upward from the floor to form a base container configured such that a grease bin can rest on the floor inside the base container. At least one wall includes a grease filtering portion operative to allow water to flow through the grease filtering portion of the wall and operative to filter grease from the water flowing through the grease filtering portion of the wall such that water can flow out of the base container through the grease filtering portion, and such that grease is substantially retained in the base container.

### BACKGROUND

Kitchen grease includes cooking oil such as is typically used for deep frying various foods, and other organic fat that is collected during conventional cooking operations. In commercial kitchens such as restaurants, banquet halls, and the like significant amounts of such kitchen grease is collected every day. For example cooking oil can only be used for a defined time before it is removed from a deep fryer and replaced. In commercial operations, kitchen grease is commonly collected in large grease bins that are periodically emptied by a grease collection agency for disposal. Typically such agencies supply the grease bins which are configured such that the agency's trucks can conveniently pick up the bins, dump the contents into tanks on the truck, and replace the bins in a desired location.

Grease bins then are typically located in a parking lot or alley near a rear kitchen entrance, away from the public, but convenient for carrying grease from the kitchen to the bin. Both when persons are placing grease into the grease bin, and when the grease collection agency raises, empties the bins, spillage occurs to a greater or lesser extent. Also vandals often tip the grease bin. In a typical grease bin location spilled grease is present on the ground surface around the bin, and also commonly flows under the bin, and is tracked into buildings and vehicles. In addition to being unsightly, this spilled grease often causes damage to paved or concrete surfaces on which the grease bin is located.

### SUMMARY OF THE INVENTION

It is an object of the present invention to provide a containment base apparatus for kitchen grease bins that overcomes problems in the prior art.

In a first embodiment the present invention provides a containment base apparatus for containing kitchen grease spilled at a grease bin location. The apparatus comprises a floor and walls extending upward from the floor to form a base container configured such that a grease bin can rest on the floor inside the base container. At least one wall includes a grease filtering portion operative to allow water to flow through the grease filtering portion of the wall and operative to filter grease from the water flowing through the grease filtering portion of the wall such that water can flow out of the base container through the grease filtering portion, and such that grease is substantially retained in the base container.

In a second embodiment the present invention provides a grease bin containment apparatus comprising a floor and walls extending upward from the floor to form a base container, and a grease bin resting on the floor inside the base container. At least one wall includes a grease filtering portion operative to allow water to flow through the grease filtering portion of the wall and operative to filter grease from the water flowing through the grease filtering portion of the wall such that water can flow out of the base container through the grease filtering portion, and such that grease is substantially retained in the base container.

Kitchen grease typically will float on top of water, such that if the base fills with water from rain or melting snow, the grease would collect on top of the water and flow over the walls leaving the base container filled with water instead of grease. The grease filter allows the water to flow out of the base container through the filter, while grease is retained in the filter.

The base also typically includes bridge members extending upward from the floor to support the grease bin above the floor to allow water to flow under the bin. Similarly skid runners under the floor support the floor above the ground and allow the base to skid along the ground surface if bumped. Front and rear cradle members extend up from the base and act to guide the grease bin into the base container during placement and also prevent tipping by vandals. The base can also be configured to provide a step to facilitate pouring kitchen grease into the grease bin. The step could have a mesh top so spilled grease passes through into the container.

Spilled kitchen grease that would conventionally collect on the ground or pavement around the grease bin collects in the base container, and can be periodically removed as required.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a perspective view of an embodiment of a containment base apparatus of the invention for containing spills from a kitchen grease bin;

FIG. 2 is a side view of the embodiment of FIG. 1 with a grease bin in place, and showing the addition of front and rear cradle members to prevent tipping and guide the grease bin into the correct location on the apparatus;

FIG. 3 is a front view of the embodiment of FIG. 1 with a grease bin in place, and showing the addition of a front cradle member to guide the grease bin into the correct location on the apparatus.

### DETAILED DESCRIPTION OF THE ILLUSTRATED EMBODIMENTS

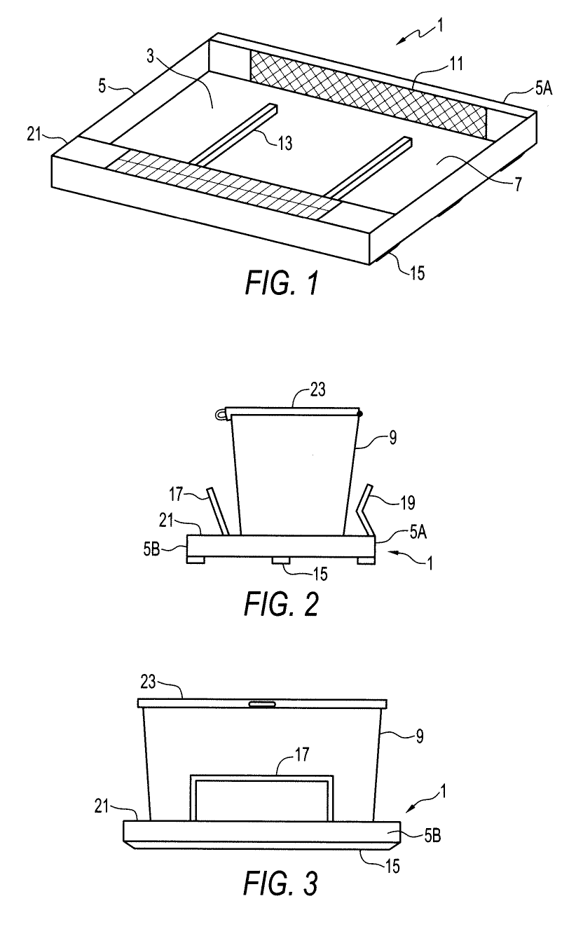

FIGS. 1-3 illustrate an embodiment a containment base apparatus 1 of the present invention for containing kitchen grease spilled at a grease bin location. The apparatus 1 comprises a floor 3 and walls 5 extending upward from the floor 3 to form a base container 7. The apparatus 1 is configured such that a grease bin 9 being used will rest on the floor 3 of the apparatus 1 inside the base container 7. The surfaces of the floor 3 and walls 5 forming the inside of the base container 7 can be coated to protect them.

In the illustrated embodiment the back wall 5A includes a grease filtering portion provided by a grease filter 11. It is contemplated that the grease filtering portion could be provided in any wall 5, but since persons depositing grease in the grease bin 9 will approach the apparatus 1 from the front, it is desirable to direct water flowing out of the base container 7 throughout the back wall 5A. The filter 11 is of the type known in the art that is operative to filter grease from water such that water can flow out of the container 7 through the filter, but kitchen grease is retained in the container. The Grease Snake™ manufactured by Flame Gard, Inc. of Los Angeles, Calif., U.S.A. for example will serve the purpose.

The illustrated grease filter 11 is configured to extend along substantially the entire length of the back wall 5A, and extends from the floor 3 to the top of the back wall 5A. Since the filter 11 extends right down to the floor 3, virtually no water will collect in the container 7 unless the bottom portion of the filter 11 is plugged. The apparatus 1 can be configured and located such that the floor 5 slopes toward the filter to promote drainage.

The large size of the illustrated filter 11 provides a significant filter area to ensure that water can exit the container 7 through the filter 11 instead of accumulating until it rises to the top of the walls 5 when kitchen grease floating on the surface of the water will spill over the walls 5. It is contemplated that considerable variations in the configuration of the filter 11 can be made while still performing the required function. The filter media can be changed when it is seen to be plugging or when water flow there-through appears to be impeded.

The illustrated containment base apparatus 1 also includes bridge members 13 extending upward from the floor 5 to support the grease bin 9 above the floor 5 to allow water to flow under the bin 9. Similarly skid runners 15 are attached to the bottom surface of the floor 5 to both reinforce the relatively thin plate material of the floor 5, and also to support the apparatus 1 above the ground to promote air circulation and prevent corrosion and rust, etc. The illustrated skid runners 15 are made from steel tubing that has rounded somewhat rounded edges and are tapered at the ends to allow the apparatus 1 to skid along the ground surface if bumped.

FIGS. 2 and 3 illustrate a front cradle member 17, and FIG. 3 illustrates a rear cradle member 19 added to the apparatus 1. The cradle members 17, 19 extend up from the front and back portions of the base container 7 and act to guide the grease bin 9 into the base container 7 during placement. The front cradle member 17 slopes forward and upward from a front portion of the base container 7, and an upper portion of the rear cradle member 19 slopes rearward and upward from a rear portion of the base container 7. The slope of the cradle members 17, 19 is configured such that a grease bin being lowered down onto the floor 3 of the base container 7, as is typical with the loading equipment typically used to handle such grease bins, will be guided onto the floor 3 of the base container 7 by contact with one or both of the front and rear cradle members 17, 19. The cradle members 17, 19 also help to prevent vandals from tipping over the grease bin 9.

The front wall 5B of the illustrated apparatus 1 also provides a step 21 to allow a person to climb up to an elevated position to more easily raise the lid 23 and pour kitchen grease into the grease bin 9 with reduced spillage. Further steps can be configured for added convenience. The step 21 has a mesh surface so any spilled grease passes through into the bin.

Kitchen grease is typically a fairly viscous liquid. When collection trucks dump the contents of the grease bin 9, it is very difficult to prevent at least some grease from running down the side of the grease bin 9. With the grease bin 9 contained by the apparatus 1 of the present invention, that grease is collected in the base container 7 and so does not damage a concrete or paved surface on which the grease bin 9 is located.

A method of containing kitchen grease spilled at a grease bin location comprises providing at the location a base container 7 with a floor 3 and walls 5 extending upward from the floor 3 and placing a grease bin 9 on the floor 3 inside the base container 7. A grease filtering portion, such as grease filter 11, is provided in one of the walls to allow water to flow through the grease filtering portion and to filter grease from the water flowing through the grease filtering portion. Thus water flows out of the base container 7 through the grease filtering portion, but grease is substantially retained in the container 7.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A containment base apparatus for containing kitchen grease spilled at a grease bin location, the apparatus comprising:
a floor and walls extending upward from the floor to form a base container configured such that a grease bin can rest on the floor inside the base container;
wherein at least one wall includes a grease filtering portion operative to allow water to flow through the grease filtering portion of the wall and operative to filter grease from the water flowing through the grease filtering portion of the wall such that water can flow out of the base container through the grease filtering portion, and such that grease is substantially retained in the base container.

2. The apparatus of claim 1 further comprising a front cradle member extending upward from a front portion of the base container, and a rear cradle member extending upward from a rear portion of the base container, the front and rear cradle members configured to guide a grease bin onto the floor of the base container.

3. The apparatus of claim 2 wherein the front cradle member slopes forward and upward from the front portion of the base container, and the rear cradle member slopes rearward and upward from the rear portion of the base container, such that a grease bin being lowered down onto the floor of the base container will be guided onto the floor of the base container by contact with one of the front and rear cradle members.

4. The apparatus of claim 1 wherein a front wall of the base container provides at least one step configured to allow a person to climb up to an elevated position to facilitate access to a grease bin resting in the base container.

5. The apparatus of claim 4 wherein the at least one step comprises a mesh surface operative to allow grease falling on the at least one step to fall through the mesh into the base container.

6. The apparatus of claim 1 wherein the grease filtering portion extends along substantially an entire length of a wall, and extends substantially from the floor to an upper portion of the wall.

7. The apparatus of claim 1 wherein the floor is configured to slope toward the grease filtering portion.

8. The apparatus of claim 1 wherein the floor includes bridge members extending upward from a floor surface and configured to support a grease bin above the floor surface such that water flows under the bin.

9. The apparatus of claim 1 wherein the floor comprises a plate and skid runners attached to a bottom surface of the plate and configured to reinforce the plate and support the plate above the ground.

10. The apparatus of claim 9 wherein the skid runners are configured to skid along a ground surface if bumped.

11. A grease bin containment apparatus comprising:
a floor and walls extending upward from the floor to form a base container;
a grease bin resting on the floor inside the base container;
wherein at least one wall includes a grease filtering portion operative to allow water to flow through the grease filtering portion of the wall and operative to filter grease from the water flowing through the grease filtering portion of the wall such that water can flow out of the base container through the grease filtering portion, and such that grease is substantially retained in the base container.

12. The apparatus of claim 11 further comprising a front cradle member extending upward from a front portion of the base container, and a rear cradle member extending upward from a rear portion of the base container, the front and rear cradle members configured to guide the grease bin onto the floor of the base container during placement of the grease bin.

13. The apparatus of claim 12 wherein the front cradle member slopes forward and upward from the front portion of the base container, and the rear cradle member slopes rearward and upward from the rear portion of the base container, such that a grease bin being lowered down onto the floor of the base container will be guided onto the floor of the base container by contact with one of the front and rear cradle members.

14. The apparatus of claim 11 wherein a front wall of the base container provides at least one step configured to allow a person to climb up to an elevated position to facilitate access to the grease bin.

15. The apparatus of claim 14 wherein the at least one step comprises a mesh surface operative to allow grease falling on the at least one step to fall through the mesh into the base container.

16. The apparatus of claim 11 wherein a back wall of the base container includes the grease filtering portion, and wherein the grease filtering portion extends along substantially an entire length of the back wall, and extends substantially from the floor to an upper portion of the back wall.

17. The apparatus of claim 11 wherein the floor is configured to slope toward the grease filtering portion.

18. The apparatus of claim 11 wherein the floor includes bridge members extending upward from a floor surface and configured to support the grease bin above the floor surface such that water flows under the bin.

19. The apparatus of claim 11 wherein the floor comprises a plate and skid runners attached to a bottom surface of the plate and configured to reinforce the plate and support the plate above the ground.

20. The apparatus of claim 19 wherein the skid runners are configured to skid along a ground surface if bumped.
